(19) United States
(12) Patent Application Publication
(10) Pub. No.: US 2005/0110764 A1
(43) Pub. Date: May 26, 2005

(54) Battery operated device with display

(75) Inventors: Steven Charles Deane, Redhill (GB); Jason Roderick Hector, Redhill (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V.

(21) Appl. No.: 10/507,533

(22) PCT Filed: Feb. 7, 2003
(86) PCT No.: PCT/IB03/00496

(30) Foreign Application Priority Data
Mar. 13, 2002 (GB) 0205860.0

(51) Int. Cl. G09G 5/00

(52) U.S. Cl. 345/173

(57) ABSTRACT

A portable electronic device (40) comprises a display module (42) and a battery unit (44). The device has at least one further analogue input or output interface (50,52,54) (in addition to the display). The display module includes a voltage converter (48) for providing at least one voltage exceeding the battery unit voltage, and an output from the voltage converter (48) of the display module is provided to a circuit (50a, 52a, 54a) associated with the at least one further analogue input or output interface. This enables a reduction in cost and volume of the device by providing a highly integrated solution, in which a voltage converter within a display module is used also for circuitry of another interface or interfaces.

This invention relates to battery operated devices with displays, for example mobile telephones and PDAs (Personal Digital Assistants).

There are various types of display which can be used within portable devices, including active matrix and passive matrix displays, and using liquid crystal technology or electroluminescent device technology.

Active matrix liquid crystal displays are most commonly used, and these typically comprise an array of pixels arranged in rows and columns. Each pixel includes a thin film transistor switch, and each row of pixels shares a row conductor which connects to the gates of the thin film transistors of the pixels in the row. Each column of pixels shares a column conductor, to which pixel drive signals are provided. The signal on the row conductor determines whether the transistor is turned on or off, and when the transistor is turned on, by a high voltage pulse on the row conductor, a signal from the column conductor is allowed to pass on to an area of liquid crystal material, thereby altering the light transmission characteristics of the material.

An additional storage capacitor may be provided as part of the pixel configuration to enable a voltage to be maintained on the liquid crystal material even after removal of the row electrode pulse. U.S. Pat. No. 5,130,829 discloses in more detail the design of an active matrix display device.

The frame (field) period for active matrix display devices requires a row of pixels to be addressed in a short period of time, and this in turn imposes a requirement on the current driving capabilities of the transistor in order to charge or discharge the liquid crystal material to the desired voltage level. In order to meet these current requirements, the gate voltage supplied to the thin film transistor needs large voltage swings. For example, in a display using low temperature polysilicon transistors, the minimum row drive voltage may be around −2 Volts and the maximum around 15 Volts. This ensures the transistor is biased sufficiently to provide the required source-drain current to charge or discharge the liquid crystal material sufficiently rapidly. In amorphous silicon devices, the row conductor voltage swing is typically even higher, for example around 40 Volts.

The requirement for large voltage swings in the row conductors requires the row driver circuitry to be implemented using high voltage components.

The pixel drive signal on the column conductor also typically has a large voltage swing. For example, a 10 Volts swing on the column conductors may be required, particularly to invert the polarity of the drive voltage of the LC. The largest peak to peak voltage corresponds to the difference between the voltages for the black state in the two different polarities. The smallest peak to peak voltage corresponds to the difference between the voltages for the white state in the two different polarities. A 10 Volt peak to peak drive signal is likely to be the maximum drive voltage for a conventional TN LC cell, and different liquid crystal materials as well as different LC cell technologies (for example different twist angles and different optical configurations) will require lower voltage swings. For example a peak to peak voltage swing of 5.6 Volts may be required. This voltage will still be higher than the desired battery supply voltage for a portable battery operated device using the display.

Various drive schemes have been proposed enabling the voltage swing on the column conductors to be reduced, so that lower voltage components may be used in the column driver circuitry. However, no scheme is able to reduce the required voltage swings to levels within the range of the battery voltage (typically around 2 Volts). Therefore, the display driver circuitry includes transformer circuitry for generating from the battery the voltages needed to supply the row and column driver circuits of the display. The display module is typically manufactured as a stand alone item including these transformer circuits.

High voltages are also required in passive matrix displays, and in displays using electroluminescent display devices rather than liquid crystal displays. These displays also therefore require voltage conversion from a battery voltage.

Some voltage conversion is also typically required by other parts of the device, where analogue voltages greater than the battery voltage are needed.

According to the invention, there is provided a portable electronic device comprising a display module and a battery unit for driving the device, the device having at least one further analogue input or output interface, wherein the display module comprises a voltage converter for providing at least one voltage exceeding the battery unit voltage, and wherein an output from the voltage converter of the display module is provided to a circuit associated with the at least one further analogue input or output interface.

The invention enables a reduction in cost and volume of the device by providing a highly integrated solution, in which a voltage converter within a display module is used also for circuitry of another interface or interfaces.

The display module may comprise an active matrix LCD module, comprising row and column driver circuits. These circuits require the higher voltage output of the voltage converter.

The circuit associated with the at least one further analogue input or output interface may comprise one or more of a speaker driver circuit, a microphone amplifier and a touch-sensitive screen interface. Thus, the extra interface is a microphone, speaker and/or touch screen, and these all require supply voltages which may exceed the battery unit voltage.

The circuit associated with at least one further analogue input or output interface is preferably provided within the display module, so that the display module will incorporate circuit elements previously provided in other circuits of the device.

By incorporating all analogue circuitry of the device into the display module, a digital interface can be provided between the display module and the remaining circuitry of the device.

The voltage converter may provide a first output for the row driver circuit and a second output for the column driver circuit, and an additional output or outputs for the or each additional interface circuit.

In addition to the interface circuits, the display module may comprise additional circuit elements, such as operational amplifiers, power amplifiers etc. These may be provided as redundant components but which can be configured by the customer for a variety of uses.

The invention may be applied to any battery operated device having a display, such as a mobile telephone or a PDA.

The invention also provides a display module for a battery-operated portable electronic device, the module comprising a voltage converter for providing at least one voltage exceeding the battery voltage for driving the display, and wherein the display module further comprises a circuit associated with at least one further analogue input or output interface device, and wherein an output from the voltage converter of the display module is provided to the circuit.

Examples of the invention will now be described in detail with reference to the accompanying drawings, in which:

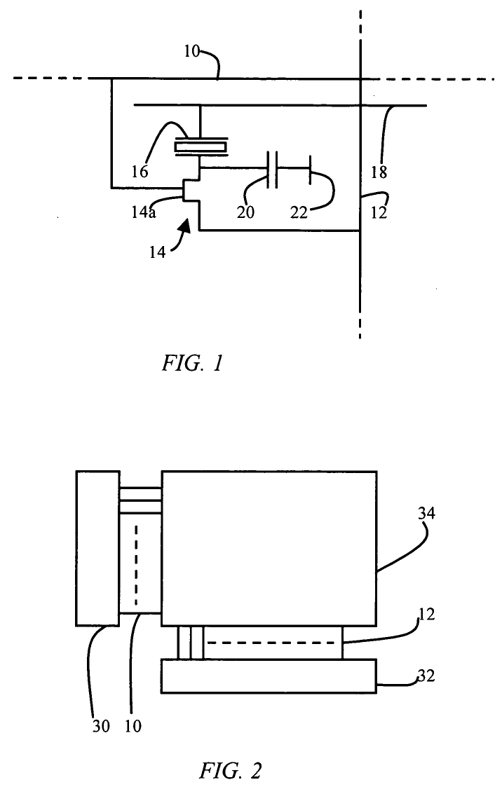

FIG. 1 shows one example of a known pixel configuration for an active matrix liquid crystal display;

FIG. 2 shows a display device including row and column driver circuitry;

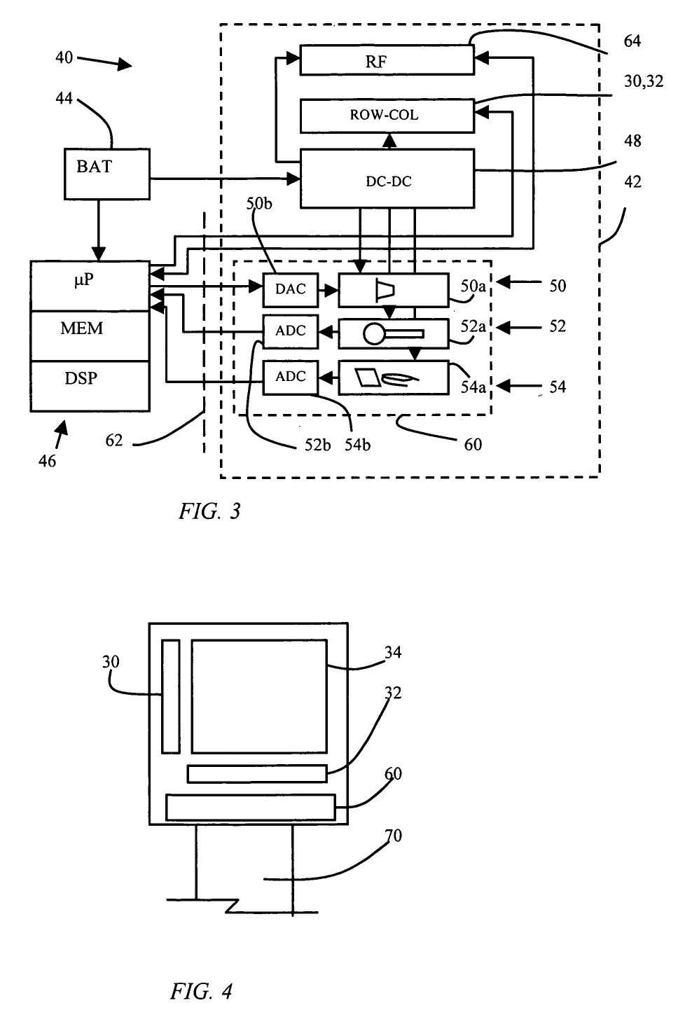

FIG. 3 shows the internal layout of a device of the invention;

FIG. 4 shows a display module of the invention; and

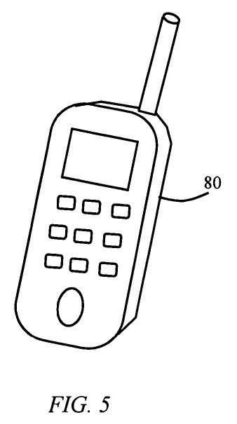

FIG. 5 shows a mobile telephone of the invention.

FIG. 1 shows a conventional pixel configuration for an active matrix liquid crystal display. The display is arranged as an array of pixels in rows and columns. Each row of pixels shares a common row conductor 10, and each column of pixels shares a common column conductor 12. Each pixel comprises a thin film transistor 14 and a liquid crystal cell 16 arranged in series between the column conductor 12 and a common potential 18. The transistor 14 is switched on and off by a signal provided on the row conductor 10. The row conductor 10 is thus connected to the gate 14a of each transistor 14 of the associated row of pixels. Each pixel may additionally comprise a storage capacitor 20 which is connected at one end 22 to the next row electrode, to the preceding row electrode, or to a separate capacitor electrode. This capacitor 20 in combination with the capacitance of the LC cell stores a drive voltage so that a signal is maintained across the liquid crystal cell 16 even after the transistor 14 has been turned off.

In order to drive the liquid crystal cell 16 to a desired voltage to obtain a required gray level, an appropriate signal is provided on the column conductor 12 in synchronism with a row address pulse on the row conductor 10. This row address pulse turns on the thin film transistor 14, thereby allowing the column conductor 12 to charge the liquid crystal cell 16 to the desired voltage, and also to charge the storage capacitor 20 to the same voltage. At the end of the row address pulse, the transistor 14 is turned off, and if a storage capacitor 20 is used then this maintains a voltage across the cell 16 when other rows are being addressed. The storage capacitor 20 reduces the effect of liquid crystal leakage and reduces the percentage variation in the pixel capacitance caused by the voltage dependency of the liquid crystal cell capacitance. The rows are addressed sequentially so that all rows are addressed in one frame period, and refreshed in subsequent field periods.

As shown in FIG. 2, the row address signals are provided by row driver circuitry 30, and the pixel drive signals are provided by column address circuitry 32, to the array 34 of display pixels.

In order to enable a sufficient current to be driven through the thin film transistor 14, which is implemented as an amorphous silicon or polycrystalline silicon thin film device, a high gate voltage must be used. In particular, the period during which the transistor is turned on is approximately equal to the total frame period within which the display must be refreshed, divided by the number of rows. It is well known that the gate voltage for the on-state and the off-state differ by approximately 40 volts for amorphous silicon devices, in order to provide the required small leakage current in the off-state, and sufficient current flow in the on-state to charge or discharge the liquid crystal cell 16 within the available time. As a result, the row driver circuitry 30 uses high voltage components. The column driver circuitry 32 is typically made using a CMOS process which supports an analogue 5V or 3.3V supply.

In order to provide these voltages to the row and column driver circuits, the display module includes analogue voltage conversion circuitry which is driven by the battery and which outputs the required voltage levels for the row and column driver circuits 30,32.

FIG. 3 shows the internal configuration of a device in accordance with the invention.

The device 40 comprises a portable electronic device having a display module 42, a battery unit 44 and digital circuitry 46. The display module includes a DC to DC voltage converter 48 for generating from the battery unit voltage the required voltages for the row and column driver circuits 30,32 of the display (the actual display panel is not shown in FIG. 3).

The device 40 has at least one further analogue input or output interface device. In the example shown in FIG. 3, there is a speaker output 50, a microphone input 52 and a touch sensitive screen input 54. Each interface device has an associated analogue circuit 50a, 52a, 54a and a digital-to-analogue or analogue-to-digital converter circuit 50b, 52b, 54b. The analogue circuits comprise a speaker driver circuit, a microphone amplifier and a touch-sensitive screen interface circuit.

In accordance with the invention, the voltage converter 48 of the display module provides the required voltages to the analogue circuits 50a, 52a, 54a. The required voltage in each case can then exceed the battery unit voltage.

By sharing the converter 48, a reduction in cost and volume of the device is enabled.

As shown in FIG. 3, the analogue circuitry for the additional interface devices are provided within the display module 42. The display module thus incorporates circuit elements previously provided in other circuits of the device. These circuit elements are grouped in the section 60.

By incorporating all analogue circuitry of the device into the display module, a digital interface 62 can be provided between the display module and the remaining circuitry 46 of the device. As shown, this remaining circuitry typically includes (at least) a memory MEM, a microprocessor μP and digital signal processor circuitry DSP.

The RF circuitry 64 (for example for a mobile telephone) is also shown within the display module in FIG. 3. This may or may not use the converter 48, and may of course remain off the display module board even if the converter 48 is to be used.

In addition to the interface circuits, the display module may comprise additional circuit elements, such as operational amplifiers, power amplifiers etc. These may be provided as redundant components but which can be configured by the customer for a variety of uses. For example, circuitry for an infra-red interface (i.e. for a remote control) may be provided. Other circuits (not necessarily interface circuits) may also be integrated into the display module, for example for controlling a display light source.

The row and column driver circuits 30,32 may be fabricated using different technologies, and some of the components within section 60 may be suitable for integration with the row driver circuit and other components may be suitable for integration with the column driver circuit.

FIG. 4 shows a display module in accordance with the invention, in which the additional analogue circuitry is shown as 60. The interface to the module comprises a connection foil 70, on which digital signals and the battery voltage are carried.

The invention may be applied to any battery operated device having a display, such as a mobile telephone or a PDA. FIG. 5 shows the device of the invention implemented as a mobile telephone 80.

Although the device described above uses an active matrix LC display, the invention can be applied to other types of display, provided the display driver circuitry requires operating voltages exceeding the battery voltage. For example, the display may comprise an electroluminescent display and may also be passively addressed. Other features of the invention will be apparent to those skilled in the art.

1. A portable electronic device comprising a display module and a battery unit for driving the device, the device having at least one further analogue input or output interface, wherein the display module comprises a voltage converter for providing at least one voltage exceeding the battery unit voltage, and wherein an output from the voltage converter of the display module is provided to a circuit associated with the at least one further analogue input or output interface.

2. A device as claimed in claim 1, wherein the display module comprises an active matrix LCD module, comprising row and column driver circuits.

3. A device as claimed in claim 1, wherein the circuit associated with the at least one further analogue input or output interface comprises one or more of a speaker driver circuit, a microphone amplifier and a touch-sensitive screen interface.

4. A device as claimed in claim 1, wherein the circuit associated with at least one further analogue input or output interface is provided within the display module.

5. A device as claimed in claim 1, wherein a digital interface is provided between the display module and the remaining circuitry of the device.

6. A device as claimed in claim 1, wherein the voltage converter provides a first output for the row driver circuit and a second output for the column driver circuit, and an additional output or outputs for the or each circuit.

7. A device as claimed in claim 1 wherein the display module comprises additional circuit elements.

8. A device as claimed in claim 1 comprising a mobile telephone or a PDA.

9. A display module for a battery-operated portable electronic device, the module comprising a voltage converter for providing at least one voltage exceeding the battery voltage for driving the display, and wherein the display module further comprises a circuit associated with at least one further analogue input or output interface device, and wherein an output from the voltage converter of the display module is provided to the circuit.
